(19) United States
(12) Patent Application Publication
(10) Pub. No.: US 2010/0214772 A1
(43) Pub. Date: Aug. 26, 2010

(54) Can cover

(76) Inventor: Grant Magdovitz, Palm Desert, CA (US)

Correspondence Address: Robert M. Sperry, Esq., 23390 Ostronic Drive, Woodland Hills, CA, 91367, US

(21) Appl. No.: 12/378,769

(22) Filed: Feb. 20, 2009

(51) Int. Cl. F21S 8/00

(52) U.S. Cl. 362/147

(57) ABSTRACT

A can cover for a recessed can light which extends over the entire mouth of the can and which has a friction fit within the can and which is provided with an internally threaded stud may be provided on the interior of the can cover to allow installers to engage the stud with a pole like apparatus to facilitate removal of the can cover.

### FIELD OF INVENTION

This invention relates to building construction and is particularly directed to improved means for covering recessed lighting fixtures for painting and the like.

### BACKGROUND

In the new construction of the building, it is common for carpenters to erect the framing. Thereafter, the electricians come in, lay the electrical wiring and install the recessed can light fixtures. Drywallers then install the drywall for ceilings and cut any necessary holes for new recessed can lights. If drywall has already been installed prior to electrician, then electrician will cut hole in ceiling drywall for a remodel recessed can light, which contains the bulb socket. However, some means must be provided to protect the bulb socket against subsequently being painted over, since that would prevent electrical contact between the bulb and the socket. Electrical tape has sometimes been used to cover the bulb socket. However, since the bulb socket is recessed within the “can”, it is difficult to reach to apply and remove such tape. Caps have also been proposed for the bulb socket. However, again, these caps are difficult to apply and remove because the bulb socket is recessed within the “can”. Also, covering the bulb socket does not prevent paint from being applied to the interior surfaces of the recessed can light. The can cover provides protection by covering the mouth of the recessed can light, hence preventing paint from being applied to the interior surface. This will protect the recessed can light UL approval sticker from paint and drywall texture. It also will protect the light trim replacement and light bulb maximum wattage replacement stickers on the interior surface of the recessed can light. Thus, none of the prior art solutions have been entirely satisfactory.

### BRIEF SUMMARY AND OBJECTS OF INVENTION

These disadvantages of the prior art are overcome with the present invention of the can cover which will prevent paint from being applied to the interior surface of the recessed can light and protecting the recessed can light UL approval sticker from paint and drywall texture. Protects light trim and light bulb maximum wattage replacement sticker on the interior surface of the recessed can light. Furthermore, the can cover of the present invention can be quickly and easily installed and removed without requiring special tools or experience.

These advantages of the present invention are preferably attained by providing a can cover which extends over the entire mouth of the can and which has a friction fit within the can, also, if desired, an internally threaded stud may be provided on the interior of the can cover to allow painters to engage the stud with a threaded pole like apparatus to facilitate removal of the can cover.

Accordingly, it is an object of the present invention to provide a can cover for a recessed can light.

An additional object of the present invention is to provide a can cover for a recessed can light which extends over the entire mouth of the can.

A further object of the present invention is to provide a can cover for a recessed can light which extends over the entire mouth of the recessed can light and which has a friction fit within the can.

A specific object of the present invention is to provide a can cover for a recessed can light which extends over the entire mouth of the can and which has a friction fit within the can and which is provided with an internally threaded stud may be provided on the interior of the can cover to allow installers to engage the stud with a pole like apparatus to facilitate removal of the can cover.

These and other objects and features of the present invention will be apparent from the following detailed description, taken with reference to the figures of the accompanying drawing.

### BRIEF DESCRIPTION OF THE DRAWING

FIG. 1 is a sectional view of a recessed can light with a recessed can cover embodying the present invention ready to be installed in the mouth of the can cover; and

FIG. 2 is a plan view of the can cover of FIG. 1.

### DETAILED DESCRIPTION OF THE INVENTION

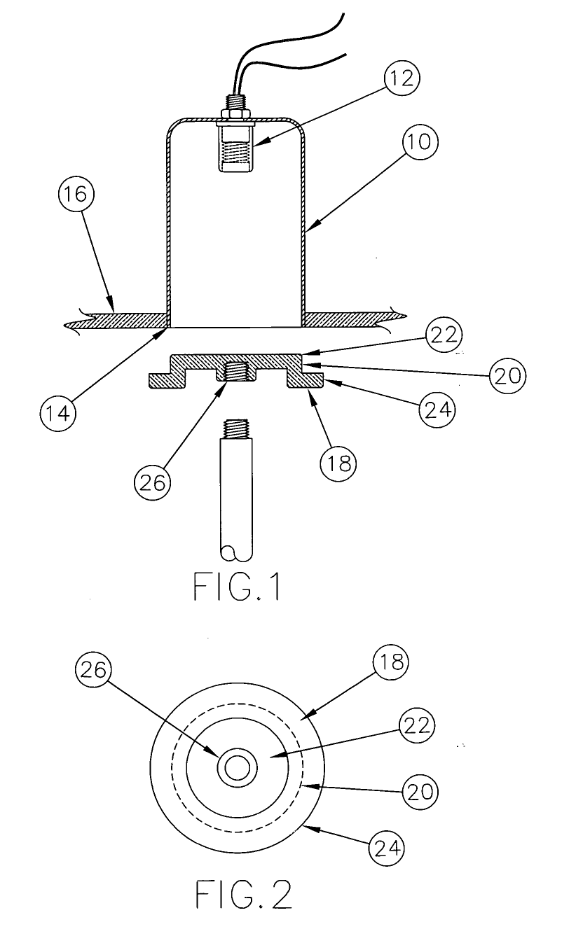

In that form of the present invention chosen for purposes of illustration, FIG. 1 shows a recessed can light 10 containing a bulb socket 12 mounted in an opening 14 in a ceiling 16 with a can cover 18, embodying the present invention about to be inserted into the opening 14 As shown, the can cover 18 is a cup-like member having side walls 20 extending rearwardly about the periphery of said base 22 and having a flanged or no flange, rim 24. The can cover 18 is installed by inserting it into the opening 14. The side walls 20 have a frictional fit within the opening 14 to releasably retain the can cover 18 with the rim 24 overlying the edges of the opening 14. Once the can cover 18 has been installed, painters can paint freely without any danger of painting the bulb socket 12 Protecting the UL approval sticker, light trim replacement and maximum bulb wattage replacement stickers and the interior aesthetics of the recessed can light 10. If desired, the can cover 18 may be provided with an internally threaded stud 26 which projects rearwardly from the base 22 between the side walls 24. After the painting is completed, the painter can remove the can cover 18 by screwing the threaded end of a painters pole like apparatus into the stud 26 and simply pulling the can cover out of the opening 14.

Obviously, numerous variations and modifications can be made without departing from the spirit of the present invention. Therefore, it should be clearly understood that the form of the present invention described above and shown in the figures of the accompanying drawing are illustrative only and are not intended to limit the scope of the present invention.

What is claimed is:

1. A can cover for a recessed lighting can comprising:
A cup-like member having a base,
side walls extending rearwardly about the periphery of said base, and
said side walls having a frictional fit with the interior of said recessed 4 can light.

2. The can cover of claim 1 further comprising:
a rim projecting outwardly from the rear edge of said side walls.

3. The can cover of claim 1 further comprising:
an internally threaded stud projecting rearwardly from said base within said side walls.

4. The can cover of claim 1 wherein:
said can cover is releasably insertable into said recessed can light.
